(19) United States
(12) Patent Application Publication
(10) Pub. No.: US 2009/0249172 A1
(43) Pub. Date: Oct. 1, 2009

(54) METHODS AND APPARATUS FOR IMPROVED DECODING OF BURSTS THAT INCLUDE MULTIPLE CONCATENATED PROTOCOL DATA UNITS

(75) Inventors: Tom Chin, San Diego, CA (US); Kuo-Chun Lee, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/056,183

(22) Filed: Mar. 26, 2008

(51) Int. Cl. H04L 1/00; G06F 11/07

(52) U.S. Cl. 714/799; 714/E11.024

(57) ABSTRACT

A corrupted protocol data unit (PDU) within a received burst of data may be identified. The received burst of data may include multiple concatenated PDUs. The received burst of data may continue to be processed despite the identification of the corrupted PDU. A next PDU in the received burst of data may be identified after the corrupted PDU is identified.

### TECHNICAL FIELD

The present disclosure relates generally to wireless communication systems. More specifically, the present disclosure relates to methods and apparatus for improved decoding of bursts that include multiple concatenated protocol data units.

### BACKGROUND

Wireless communication devices have become smaller and more powerful in order to meet consumer needs and to improve portability and convenience. Consumers have become dependent upon wireless communication devices such as cellular telephones, personal digital assistants (PDAs), laptop computers, and the like. Consumers have come to expect reliable service, expanded areas of coverage, and increased functionality. Wireless communication devices may be referred to as mobile stations, stations, access terminals, user terminals, terminals, subscriber units, user equipment, etc.

A wireless communication system may simultaneously support communication for multiple wireless communication devices. A wireless communication device may communicate with one or more base stations (which may alternatively be referred to as access points, Node Bs, etc.) via transmissions on the uplink and the downlink. The uplink (or reverse link) refers to the communication link from the wireless communication devices to the base stations, and the downlink (or forward link) refers to the communication link from the base stations to the wireless communication devices.

Wireless communication systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, and orthogonal frequency division multiple access (OFDMA) systems.

### BRIEF DESCRIPTION OF THE DRAWINGS

FIG. 1 illustrates a wireless communication system in which the methods and apparatus described herein may be implemented;

FIG. 2 illustrates a burst that includes multiple medium access control layer protocol data units (MPDUs);

FIG. 3 illustrates a generic header that may be included in an MPDU;

FIG. 4 illustrates a signaling header that may be included in an MPDU;

FIG. 5 illustrates an example showing certain aspects of a header search algorithm in accordance with the present disclosure;

FIG. 6 illustrates an example showing certain advantageous that may be associated with a header search algorithm in accordance with the present disclosure;

FIG. 7 illustrates an example of a method for identifying a starting point of an MPDU in a received burst of data;

FIG. 8 illustrates means-plus-function blocks associated with the method of FIG. 7;

FIG. 9 illustrates an example of a method for processing MPDUs in a received burst of data;

FIG. 10 illustrates means-plus-function blocks associated with the method of FIG. 9; and

FIG. 11 illustrates various components that may be utilized in a wireless device.

### DETAILED DESCRIPTION

The methods and apparatus of the present disclosure may be utilized in a broadband wireless communication system. The term “broadband wireless” refers to technology that provides wireless, voice, Internet, and/or data network access over a given area.

The Institute of Electronic and Electrical Engineers (IEEE) 802.16 Working Group on Broadband Wireless Access Standards aims to prepare formal specifications for the global deployment of broadband Wireless Metropolitan Area Networks. Although the 802.16 family of standards is officially called WirelessMAN, it has been called “WiMAX” (which stands for the “Worldwide Interoperability for Microwave Access”) by an industry group called the WiMAX Forum. Thus, the term “WiMAX” refers to a standards-based broadband wireless technology that provides high-throughput broadband connections over long distances.

There are two main applications of WiMAX today: fixed WiMAX and mobile WiMAX. Fixed WiMAX applications are point-to-multipoint, enabling broadband access to homes and businesses. Mobile WiMAX offers the full mobility of cellular networks at broadband speeds.

Some of the examples described herein are relevant to wireless communication systems that are configured in accordance with WiMAX standards. However, these examples should not be interpreted as limiting the scope of the present disclosure.

A Medium Access Control (MAC) layer may process data as MAC protocol data units (MPDUs). Under some circumstances, multiple MPDUs may be concatenated in the same downlink or uplink burst of data. For example, the WiMAX standards presently allow concatenation of multiple MPDUs in the same burst of data. Each MPDU may include a header, an optional payload, and an optional cyclic redundancy check (CRC). The header may include a header check sequence (HCS), the length of the MPDU, and other information. Both the HCS and the CRC may be used to detect corruption of data during transmission.

Under some circumstances, transmission errors may corrupt some, but not all, of the MPDUs within a burst of data. When the burst is decoded at the receiver, the corruption of an MPDU may be indicated by the failure to verify the HCS or the failure to verify the CRC. In a typical implementation, when the HCS or the CRC is unable to be verified, the receiver may stop decoding the burst. Thus, the corrupted MPDU and any subsequent MPDUs in the burst may be discarded. However, such an approach may not be desirable because, as mentioned, some of the remaining MPDUs in the burst may not be corrupted.

Unfortunately, it may be difficult to find the start of the next MPDU so that decoding of the burst may continue. For example, if the HCS in the header of the preceding MPDU was not verified, then the length of that MPDU may be unknown. Consequently, the start of the next MPDU may also be unknown. The present disclosure relates to techniques for allowing decoding of remaining MPDU(s) in a received burst of data when the decoding of a preceding MPDU in the burst has failed.

In accordance with a method for improved decoding in a wireless communication system, a corrupted protocol data unit (PDU) within a received burst of data may be identified. The received burst of data may include multiple concatenated PDUs. The received burst of data may continue to be processed despite the identification of the corrupted PDU. The next PDU in the received burst of data after the corrupted PDU may be identified.

An apparatus for improved decoding in a wireless communication system may include a processor and memory in electronic communication with the processor. Instructions may be stored in the memory. The instructions may be executable to identify a corrupted protocol data unit (PDU) within a received burst of data. The received burst of data may include multiple concatenated PDUs. The instructions may also be executable to continue to process the received burst of data despite the identification of the corrupted PDU. The instructions may also be executable to identify a next PDU in the received burst of data after the corrupted PDU is identified.

An apparatus for improved decoding in a wireless communication system may include means for identifying a corrupted protocol data unit (PDU) within a received burst of data. The received burst of data may include multiple concatenated PDUs. The apparatus may also include means for continuing to process the received burst of data despite the identification of the corrupted PDU. The apparatus may also include means for identifying a next PDU in the received burst of data after the corrupted PDU is identified.

A computer-program product for providing improved decoding in a wireless communication system may include a computer readable medium having instructions thereon. The instructions may include code for identifying a corrupted protocol data unit (PDU) within a received burst of data. The received burst of data may include multiple concatenated PDUs. The instructions may also include code for continuing to process the received burst of data despite the identification of the corrupted PDU. The instructions may also include code for identifying a next PDU in the received burst of data after the corrupted PDU is identified.

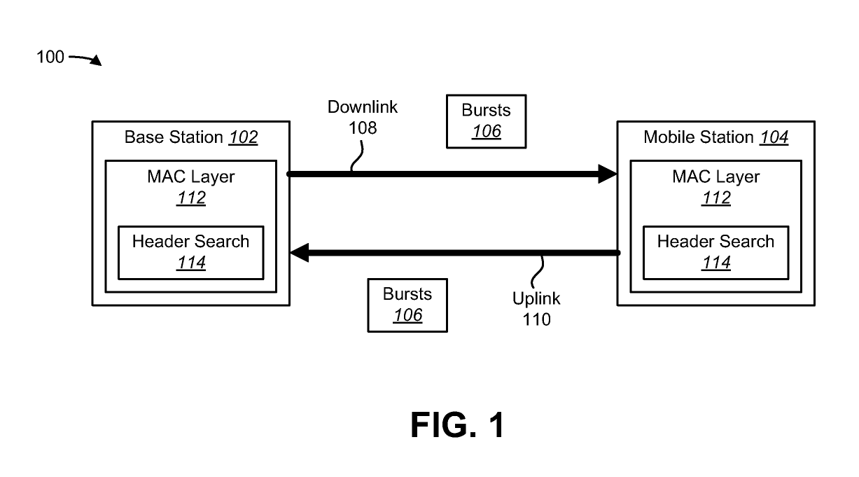

FIG. 1 illustrates a wireless communication system 100 in which the methods and apparatus described herein may be implemented. A base station 102 is shown in wireless electronic communication with a mobile station 104. For simplicity, only one base station 102 and one mobile station 104 are shown in FIG. 1. However, a wireless communication system 100 may include multiple base stations 102, each of which may be in electronic communication with multiple mobile stations 104.

The base station 102 may transmit bursts 106 of data to the mobile station 104 on a downlink 108. The mobile station 104 may transmit bursts 106 of data to the base station 102 on an uplink 110. Both the base station 102 and the mobile station 104 may include a Medium Access Control (MAC) layer 112 that processes data as MAC protocol data units (MPDUs). Multiple MPDUs may be concatenated in the same burst 106.

As indicated above, each MPDU may include a header, an optional payload, and an optional cyclic redundancy check (CRC). The header may include a header check sequence (HCS), the length of the MPDU, and other information. Both the HCS and the CRC may be used to detect corruption of data during transmission.

As indicated above, a burst 106 of data may include multiple concatenated MPDUs. When the decoding of one of the MPDUs fails (e.g., the HCS or the CRC is not verified), the MAC layer 112 may nonetheless allow decoding of the remaining MPDU(s) in the burst 106. The MAC layer 112 may identify the start of the next MPDU via a header search algorithm. Both the base station 102 and the mobile station 104 are shown with a header search component 114 for providing this functionality. The header search algorithm may involve choosing one or more trial headers and then testing these trial headers via the HCS of the MPDU's header. This will be explained in greater detail below.

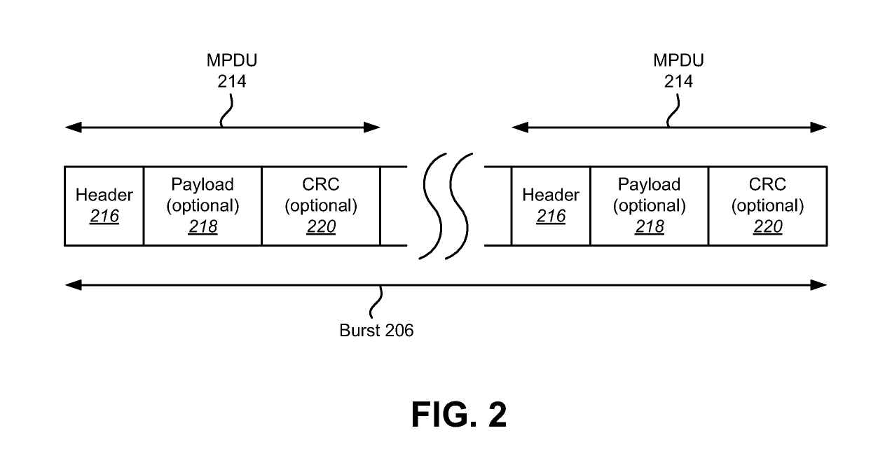

FIG. 2 illustrates a burst 206 that includes multiple MPDUs 214. Each MPDU 214 includes a header 216, an optional payload 218, and an optional cyclic redundancy check (CRC) 220. The depicted burst 206 represents transmission from a base station 102 to a mobile station 104 via a downlink 108, or from a mobile station 104 to a base station 102 via an uplink 110.

WiMAX standards define two types of MPDUs 214: generic and signaling. The signaling MPDU 214 does not have any payload, and it has a 6-octet header 216 only. The generic MPDU 214 has a 6-octet header 216, a payload 218, and a 32-bit CRC 220 (which is optional).

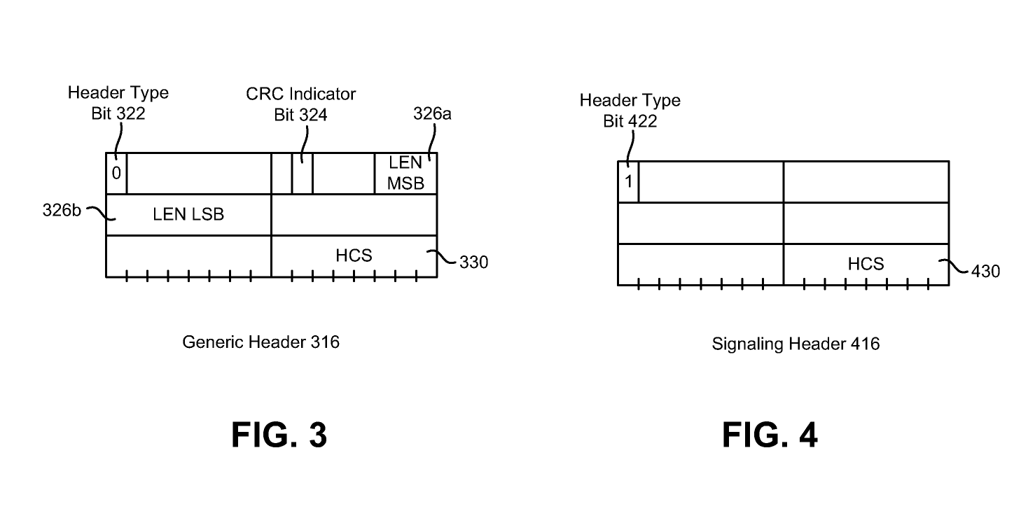

FIG. 3 illustrates a generic header 316. As shown, the generic header 316 may include a header type bit 322. In accordance with the WiMAX standards, if the value of the header type bit 322 is zero, this corresponds to a generic header 316.

The generic header 316 may also include a CRC indicator bit 324. The CRC indicator bit 324 identifies whether or not a CRC is included in the MPDU 214.

The generic header 316 may also include a length field 326. FIG. 3 shows the most significant bits (MSBs) of the length field 326a and the least significant bits (LSBs) of the length field 326b.

The generic header 316 may also include a header check sequence (HCS) 330. As indicated above, the HCS 330 may be used to detect corruption of the header 316 during transmission.

FIG. 4 illustrates a signaling header 416. As shown, the signaling header 416 may include a header type bit 422. In accordance with the WiMAX standards, if the value of the header type bit 422 is one, this corresponds to a signaling header 416. The signaling header 416 may also include an HCS 430.

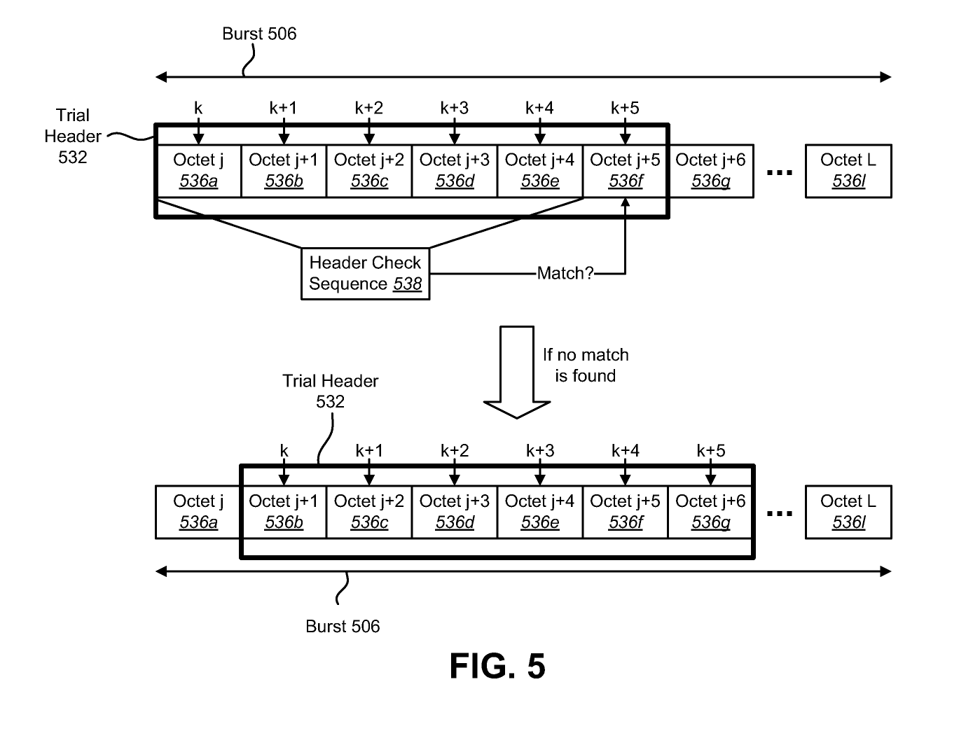

As indicated above, when the decoding of one of the MPDUs 214 within a burst 106 has failed, the MAC layer 112 may identify the start of the next MPDU 214 in the burst 106 via a header search algorithm. FIG. 5 illustrates an example showing certain aspects of a header search algorithm that may be used. The MAC layer 112 within a base station 102 and/or a mobile station 104 may be configured to operate in accordance with the depicted example.

A burst 506 of data is shown in FIG. 5. The burst 506 of data may be transmitted from a base station 102 to a mobile station 104 via a downlink 108. Alternatively, the burst 506 of data may be transmitted from a mobile station 104 to a base station 102 via an uplink 110.

The octets 536a-l within the burst 506 may be denoted with indices j, j+1, . . . , L. The octet 536a with index j may be the first octet 536a in the burst 506. The octet 536l with index L may be the last octet 536l within the burst 506.

A search index k may be defined. The header search may begin from search index k=j.

A trial header 532 may be formed. As indicated above, the header 216 within an MPDU 214 may include six octets 536. Thus, the trial header 532 may also include six octets 536. More specifically, the trial header 532 may include the six octets 536a-f corresponding to search indices k, k+1, k+2, k+3, k+4, and k+5.

The first five octets 536a-e in the trial header 532 may be used to calculate a header check sequence 538. If the sixth octet 536f in the trial header 532 matches the header check sequence 538 that is calculated, then it may be concluded that the trial header 532 corresponds to the header 216 of the next MPDU 214 in the burst 506, and thus the start of the next MPDU 214 in the burst 506 has been identified.

However, if the sixth octet 536f in the trial header 532 does not match the header check sequence 538 that is calculated, then the search index k may be incremented, so that k=j+1. A new trial header 532 may be formed, which may include the six octets 536b-g. This is shown in the bottom portion of FIG. 5. The process described above may then be repeated.

Thus, the portion of the received burst 506 of data that corresponds to the trial header 532 may be shifted in accordance with a “sliding window” approach. This may continue until a match is found between the header check sequence 538 calculated using the first five octets 536 of the trial header 532, and the value of the sixth octet 536 in the trial header 532. Once this type of match has been found, then it may be concluded that the next MPDU 214 in the burst 106 has been found, and the normal MPDU 214 decoding method may be used to parse the MPDU 214. In other words, the header search algorithm involves attempting one or more trial headers 532 until a trial header 532 is found that includes a verifiable header check sequence 538.

Under some circumstances, a match may not be found. This may be the case, for example, when all of the MPDUs 214 within a burst 506 have been corrupted. Whenever the search index k is incremented, it may be determined whether k>L−5. If so, then it may be concluded that the header search has failed.

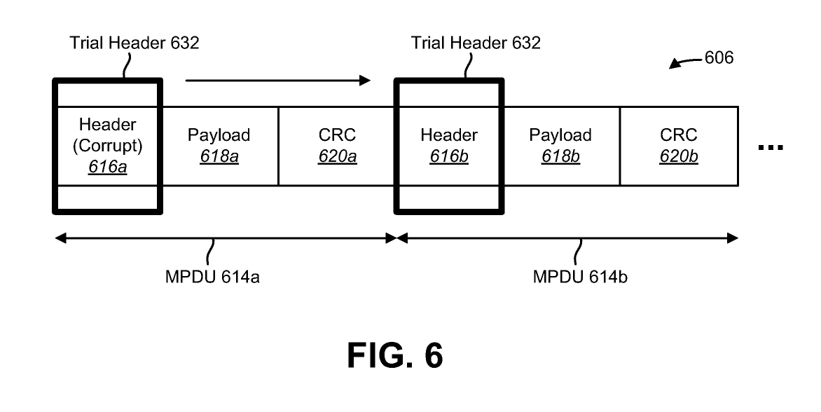

FIG. 6 illustrates an example showing certain advantageous that may be associated with a header search algorithm in accordance with the present disclosure. Such advantages may be relevant in a situation where a burst 606 that includes multiple MPDUs 614 is received, at least one of the MPDUs 614 in the burst 606 is corrupt, but not all of the MPDUs 614 in the burst 606 are corrupt.

FIG. 6 shows a burst 606 with multiple MPDUs 614. A first MPDU 614a and a second MPDU 614b within the burst 606 are shown. The first MPDU 614a includes a header 616a, a payload 618a, and a CRC 620a. The second MPDU 614b includes a header 616b, a payload 618b, and a CRC 620b. For purposes of this example, it may be assumed that the header 616a within the first MPDU 614a is corrupt. For example, the HCS 330 within the header 616a of the first MPDU 614a may not be verifiable. Furthermore, it may be assumed that the second MPDU 614b is not corrupt.

With known approaches, once it is determined that the header 616a within the first MPDU 614a is corrupted, then the entire burst 606 may be discarded. This may be at least partially due to the fact that the length of the first MPDU 614a may be unknown (because the header 616a may include the length of the first MPDU 614a, and the header 616a may be corrupted). However, such an approach may be disadvantageous, because some of the MPDUs 614 within the burst 606 may not be corrupted (as in this example).

As discussed above, the present disclosure proposes the use of a header search algorithm. The header search algorithm may have the effect of improving the decoding rate, because the received burst 606 of data may continue to be processed despite the identification of the corrupted MPDU 614a. Thus, the header search algorithm may permit decoding of uncorrupted MPDUs 614 within the burst 606, even after one or more corrupted MPDUs 614 within the burst 606 have been identified.

As discussed above, when the burst 606 is received, a trial header 632 may be formed. The trial header 632 may correspond to the corrupted header 616a in the first MPDU 614a. The first five octets 536a-e in the trial header 632 may be used to calculate a header check sequence 538. However, because the trial header 632 corresponds to the header 616a that is corrupted, the sixth octet 536f in the trial header 632 (i.e., the HCS 330 of the corrupted header 616a) does not match the header check sequence 538 that is calculated.

A new trial header 632 may then be formed, and the process described above may be repeated. Thus, the trial header 632 may move along the received burst 606 like a “sliding window.” At some point, the trial header 632 may correspond to the uncorrupted header 616b in the second MPDU 614b in the burst 606. This time, the sixth octet 536f in the trial header 632 (i.e., the HCS 330 of the uncorrupted header 616b) matches the header check sequence 538 that is calculated. Thus, the start of the next MPDU 614b in the burst 606 has been identified. The normal MPDU decoding method may then be used to parse this MPDU 614b.

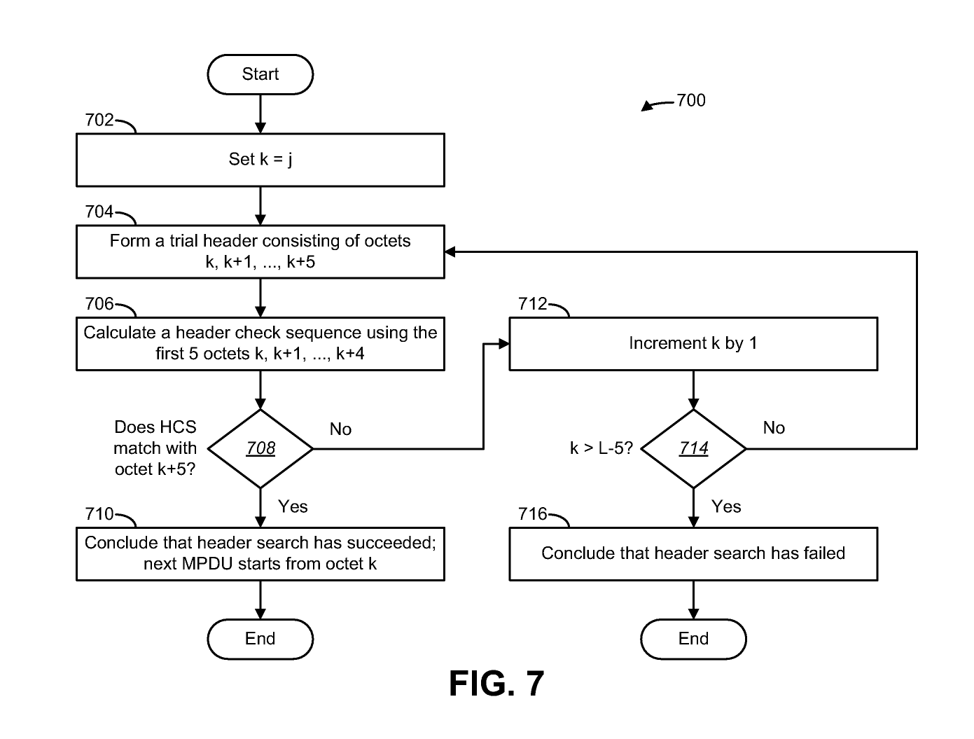

FIG. 7 illustrates an example of a method 700 for identifying a starting point of an MPDU 214 in a received burst 506 of data. As indicated above, the octets 536a-l within the burst 506 may be denoted with indices j, j+1, . . . , L.

A search index k may be defined. The header search may begin from search index k=j. Thus, the method 700 may include setting 702 k=j.

A trial header 532 may be formed 704. The trial header 532 may include the six octets 536a-f corresponding to search indices k, k+1, k+2, k+3, k+4, and k+5.

The first five octets 536a-e in the trial header 532 may be used to calculate 706 a header check sequence 538. It may then be determined 708 whether the sixth octet 536f in the trial header 532 matches the header check sequence 538 that is calculated. If so, then it may be concluded 710 that the header search has succeeded, and that the next MPDU 214 in the burst 506 starts from the octet 536a corresponding to search index k.

If it is determined 708 that the sixth octet 536f in the trial header 532 does not match the header check sequence 538 that is calculated, then the search index k may be incremented 712 by one. It may then be determined 714 whether k>L−5 (where the octet 536l with index L corresponds to the last octet 536l within the burst 506, as indicated above). If not, then a new trial header 532 may be formed 704. The new trial header 532 may include the next six octets 536b-g in the burst 506. The process described above may then be repeated with respect to this new trial header 532.

However, if it is determined 714 that k>L−5, then it may be concluded 716 that the header search has failed. The header search may fail, for example, when all of the MPDUs 214 within a burst 506 have been corrupted.

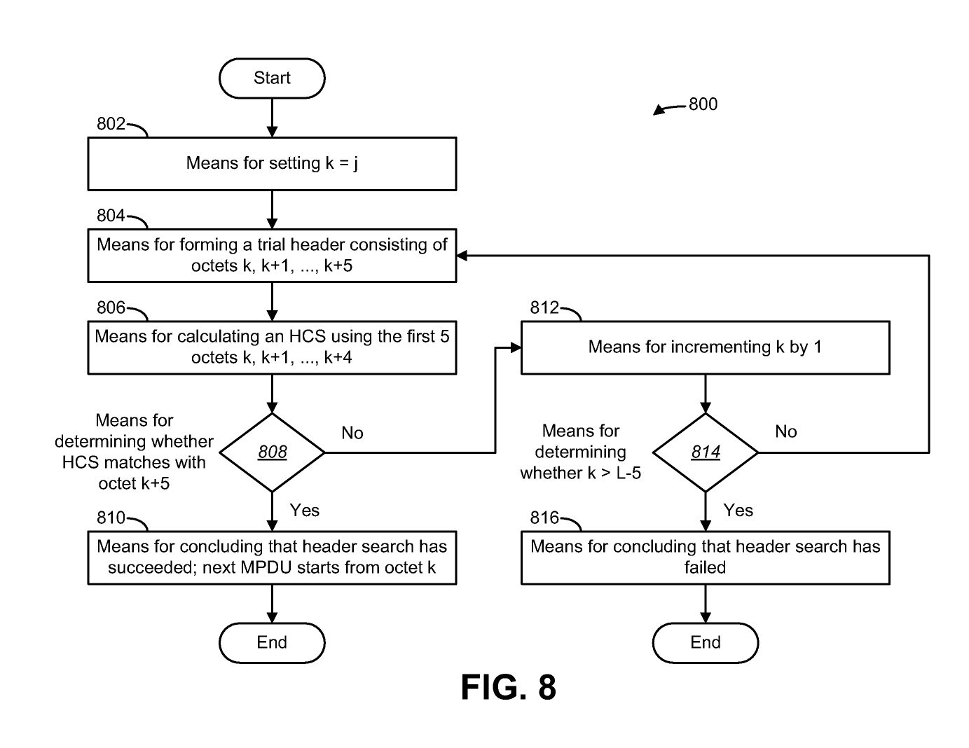

The method 700 of FIG. 7 described above may be performed by various hardware and/or software component(s) and/or module(s) corresponding to the means-plus-function blocks 800 illustrated in FIG. 8. In other words, blocks 702 through 716 illustrated in FIG. 7 correspond to means-plus-function blocks 802 through 816 illustrated in FIG. 8.

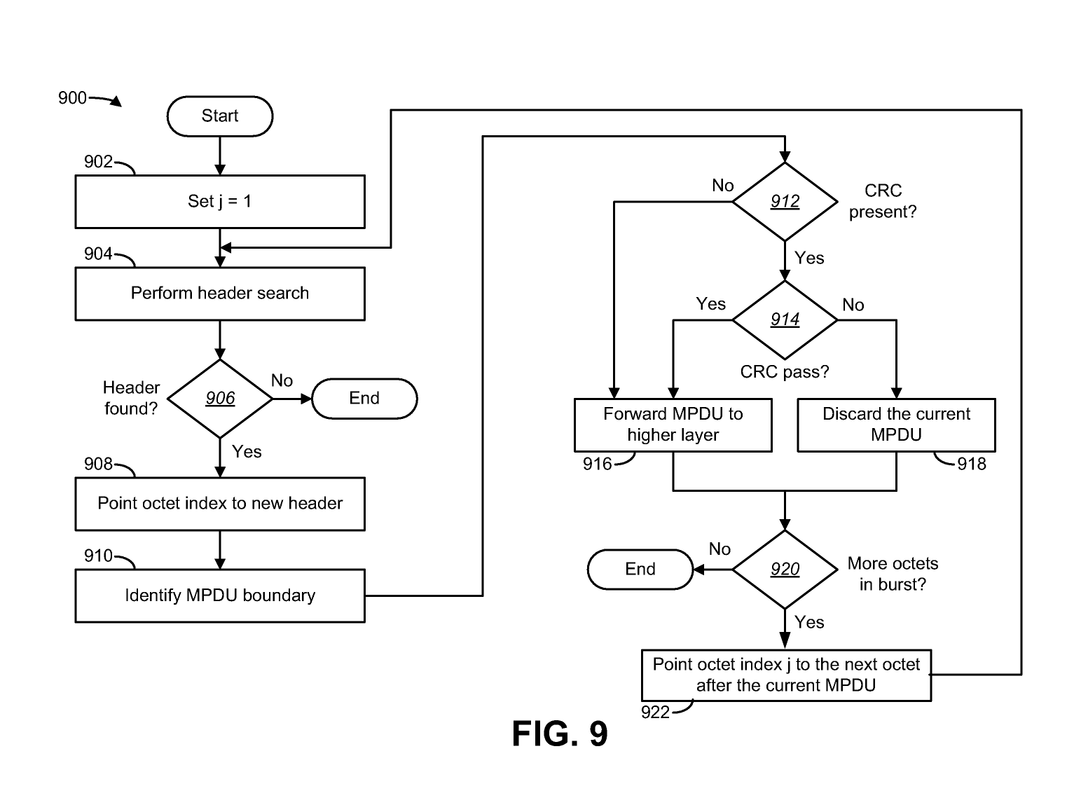

FIG. 9 illustrates an example of a method 900 for processing MPDUs 214 in a received burst 106 of data. In accordance with this method 900, when the decoding of one MPDU 214 within the burst 106 fails, the subsequent MPDUs 214 in the burst 106 may still be decoded. The method 900 may utilize the header search algorithm described previously.

The method 900 may be implemented by the MAC layer 112 within a base station 102 that has received a burst 106 of data from a mobile station 104 via an uplink 110. The method 900 may also be implemented by the MAC layer 112 within a mobile station 104 that has received a burst 106 of data from a base station 102 via a downlink 108. In either case, the burst 106 of data that is received may include multiple concatenated MPDUs 214.

In accordance with the method 900, an octet index j may be defined. The octet index j may initially be set 902 equal to one. In other words, the octet index j may initially point to the first octet 536 in the received burst 106 of data.

A header search may be performed 904. This may be done in accordance with the header search algorithm described above. As discussed above, as part of the header search algorithm, a search index k may be defined. The header search may begin from search index k=j.

If it is determined 906 that a header 216 is not found during the header search, then the method 900 may end (i.e., the burst 106 may simply be discarded without any MPDUs 214 being decoded). However, if it is determined 906 that a header 216 has been found during the header search, then the octet index points 908 to the first octet 536 in the header 216. The MPDU boundary may be identified 910 from the information contained within the header 216 (i.e., the length field 326).

It may then be determined 912 whether a CRC 220 is present in the MPDU 214. If not, then the MPDU 214 may be forwarded 916 to a higher layer. If it is determined 912 that the MPDU 214 includes a CRC 220, then an attempt may be made to verify 914 the CRC 220. If the CRC 220 is not verified 914, then the MPDU 214 may be discarded 918. However, if the MPDU 214 is verified 914, then the MPDU 214 may be forwarded 916 to a higher layer.

If it is determined 920 that there are additional octets 536 in the burst 506, then the octet index j points to the next octet after the current MPDU 922 and a new header search may be performed 904. Then the process described above may be repeated.

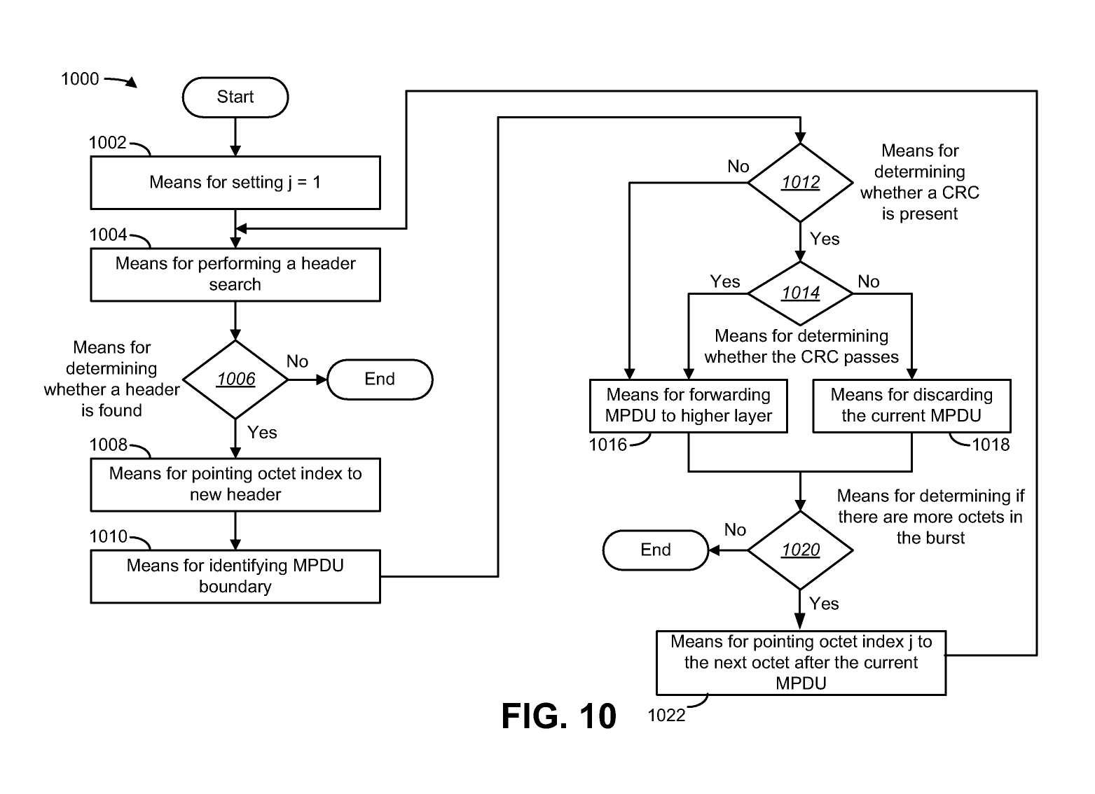

The method 900 of FIG. 9 described above may be performed by various hardware and/or software component(s) and/or module(s) corresponding to the means-plus-function blocks 1000 illustrated in FIG. 10. In other words, blocks 902 through 922 illustrated in FIG. 9 correspond to means-plus-function blocks 1002 through 1022 illustrated in FIG. 10.

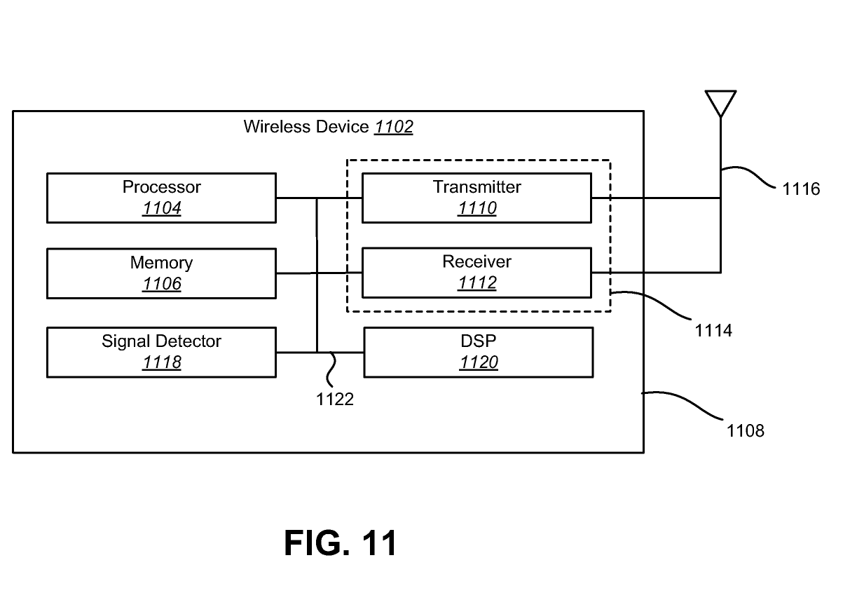

FIG. 11 illustrates various components that may be utilized in a wireless device 1102. The wireless device 1102 is an example of a device that may be configured to implement the various methods described herein. The wireless device 1102 may be a base station 102 or a mobile station 104.

The wireless device 1102 may include a processor 1104 which controls operation of the wireless device 1102. The processor 1104 may also be referred to as a central processing unit (CPU). Memory 1106, which may include both read-only memory (ROM) and random access memory (RAM), provides instructions and data to the processor 1104. A portion of the memory 1106 may also include non-volatile random access memory (NVRAM). The processor 1104 typically performs logical and arithmetic operations based on program instructions stored within the memory 1106. The instructions in the memory 1106 may be executable to implement the methods described herein.

The wireless device 1102 may also include a housing 1108 that may include a transmitter 1110 and a receiver 1112 to allow transmission and reception of data between the wireless device 1102 and a remote location. The transmitter 1110 and receiver 1112 may be combined into a transceiver 1114. An antenna 1116 may be attached to the housing 1108 and electrically coupled to the transceiver 1114. The wireless device 1102 may also include (not shown) multiple transmitters, multiple receivers, multiple transceivers and/or multiple antenna.

The wireless device 1102 may also include a signal detector 1118 that may be used to detect and quantify the level of signals received by the transceiver 1114. The signal detector 1118 may detect such signals as total energy, pilot energy per pseudonoise (PN) chips, power spectral density, and other signals. The wireless device 1102 may also include a digital signal processor (DSP) 1120 for use in processing signals.

The various components of the wireless device 1102 may be coupled together by a bus system 1122 which may include a power bus, a control signal bus, and a status signal bus in addition to a data bus. However, for the sake of clarity, the various buses are illustrated in FIG. 11 as the bus system 1122.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated by FIGS. 7, 8, 9 and 10, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for improved decoding in a wireless communication system, comprising:
identifying a corrupted protocol data unit (PDU) within a received burst of data, wherein the received burst of data comprises multiple concatenated PDUs;
continuing to process the received burst of data despite the identification of the corrupted PDU; and
identifying a next PDU in the received burst of data after the corrupted PDU is identified.

2. The method of claim 1, wherein identifying the next PDU comprises attempting one or more trial headers.

3. The method of claim 2, further comprising attempting to verify a header check sequence for each of the one or more trial headers.

4. The method of claim 2, wherein the portion of the received burst of data that corresponds to the trial header is shifted in accordance with a sliding window approach.

5. The method of claim 1, wherein identifying the corrupted PDU comprises determining that a header check sequence of the corrupted PDU is not verifiable.

6. The method of claim 1, wherein the PDU is a medium access control layer protocol data unit (MPDU).

7. The method of claim 1, wherein the method is implemented in a base station.

8. The method of claim 1, wherein the method is implemented in a mobile station.

9. The method of claim 1, wherein the wireless communication system supports an Institute of Electronic and Electrical Engineers (IEEE) 802.16 standard.

10. An apparatus for improved decoding in a wireless communication system, comprising:
a processor;
memory in electronic communication with the processor;
instructions stored in the memory, the instructions being executable to:
identify a corrupted protocol data unit (PDU) within a received burst of data, wherein the received burst of data comprises multiple concatenated PDUs;
continue to process the received burst of data despite the identification of the corrupted PDU; and
identify a next PDU in the received burst of data after the corrupted PDU is identified.

11. The apparatus of claim 10, wherein identifying the next PDU comprises attempting one or more trial headers.

12. The apparatus of claim 11, wherein the instructions are further executable to verify a header check sequence for each of the one or more trial headers.

13. The apparatus of claim 11, wherein the portion of the received burst of data that corresponds to the trial header is shifted in accordance with a sliding window approach.

14. The apparatus of claim 10, wherein identifying the corrupted PDU comprises determining that a header check sequence of the corrupted PDU is not verifiable.

15. The apparatus of claim 10, wherein the PDU is a medium access control layer protocol data unit (MPDU).

16. The apparatus of claim 10, wherein the apparatus is a base station.

17. The apparatus of claim 10, wherein the apparatus is a mobile station.

18. The apparatus of claim 10, wherein the wireless communication system supports an Institute of Electronic and Electrical Engineers (IEEE) 802.16 standard.

19. An apparatus for improved decoding in a wireless communication system, comprising:
means for identifying a corrupted protocol data unit (PDU) within a received burst of data, wherein the received burst of data comprises multiple concatenated PDUs;
means for continuing to process the received burst of data despite the identification of the corrupted PDU; and
means for identifying a next PDU in the received burst of data after the corrupted PDU is identified.

20. The apparatus of claim 19, wherein the means for identifying the next PDU comprises means for attempting one or more trial headers.

21. The apparatus of claim 20, further comprising means for attempting to verify a header check sequence for each of the one or more trial headers.

22. The apparatus of claim 20, wherein the portion of the received burst of data that corresponds to the trial header is shifted in accordance with a sliding window approach.

23. The apparatus of claim 19, wherein the means for identifying the corrupted PDU comprises means for determining that a header check sequence of the corrupted PDU is not verifiable.

24. The apparatus of claim 19, wherein the PDU is a medium access control layer protocol data unit (MPDU).

25. The apparatus of claim 19, wherein the apparatus is a base station.

26. The apparatus of claim 19, wherein the apparatus is a mobile station.

27. The apparatus of claim 19, wherein the wireless communication system supports an Institute of Electronic and Electrical Engineers (IEEE) 802.16 standard.

28. A computer-program product for providing improved decoding in a wireless communication system, the computer-program product comprising a computer readable medium having instructions thereon, the instructions comprising:
code for identifying a corrupted protocol data unit (PDU) within a received burst of data, wherein the received burst of data comprises multiple concatenated PDUs;
code for continuing to process the received burst of data despite the identification of the corrupted PDU; and
code for identifying a next PDU in the received burst of data after the corrupted PDU is identified.

29. The computer-program product of claim 28, wherein the code for identifying the next PDU comprises code for attempting one or more trial headers.

30. The computer-program product of claim 29, further comprising code for attempting to verify a header check sequence for each of the one or more trial headers.

31. The computer-program product of claim 29, wherein the portion of the received burst of data that corresponds to the trial header is shifted in accordance with a sliding window approach.

32. The computer-program product of claim 28, wherein the code for identifying the corrupted PDU comprises code for determining that a header check sequence of the corrupted PDU is not verifiable.

33. The computer-program product of claim 28, wherein the PDU is a medium access control layer protocol data unit (MPDU).

34. The computer-program product of claim 28, wherein the apparatus is a base station.

35. The computer-program product of claim 28, wherein the apparatus is a mobile station.

36. The computer-program product of claim 28, wherein the wireless communication system supports an Institute of Electronic and Electrical Engineers (IEEE) 802.16 standard.
